(19) United States
(12) Patent Application Publication
(10) Pub. No.: US 2017/0203240 A1
(43) Pub. Date: Jul. 20, 2017

(54) Filter Device Having a Quick Release Tube Coupling

(71) Applicant: PA.E. Machinery Industrial Co., Ltd., Taichung City (TW)

(72) Inventor: Ming-Yu Lai, Taichung City (TW)

(21) Appl. No.: 15/174,395

(22) Filed: Jun. 6, 2016

(30) Foreign Application Priority Data
Jan. 20, 2016 (TW) 105101623

(51) Int. Cl. B01D 35/02; B01D 29/13

(52) U.S. Cl. CPC B01D 35/02; B01D 29/13; B01D 2201/291; B01D 2201/304; B01D 2201/342

(57) ABSTRACT

A filter device includes a housing defining an accommodating space, a filter core, a cover connected to the housing, and a tube coupling. The tube coupling includes a connector body, a collet, a retaining member, and a seal ring. The connector body is connected to the cover, has opposite inner and outer end parts, and a guiding part interconnecting the inner and outer end parts, and defining a passageway that is in fluid communication with the accommodating space and that has a tapering portion tapering toward the outer end part. The tube coupling and the cover are molded as one piece. The collet is movably connected to the connector body. The retaining member is disposed at the inner end part. The seal ring is retained in the passageway.

### CROSS-REFERENCE TO RELATED APPLICATION

This application claims priority of Taiwanese Patent Application No. 105101623, filed on Jan. 20, 2016.

### FIELD

The disclosure relates to a filter device, more particularly to a filter device having a quick release tube coupling.

### BACKGROUND

Tube couplings are widely applied in piping and plumbing systems, and those manufactured by John Guest Ltd. are well-known to the public. A conventional tube coupling manufactured by John Guest Ltd. includes a hollow connector that defines a passageway, and a collet that is movably connected to the hollow connector and that is for receiving a tube. The passageway has front and middle sections in which the collet is movably disposed, and a rear section which is opposite to the front section and in which a seal ring is received. The middle section has a maximum inner diameter larger than those of the front and rear sections. In the earlier designs, such as those disclosed in U.S. Pat. No. 4,005,883 and U.S. Pat. No. 4,588,214, the hollow connector is molded as one piece, but the shape of the hollow connector leads to difficulties in removing the hollow connector out of a mold, and the hollow connector formed has a relatively poor precision. In the later designs, such as those disclosed in U.S. Pat. No. 4,650,529 and U.S. Pat. No. 4,722,560, the hollow connector is divided into separate front and rear parts to prevent difficulties when being removed from a mold. The front part forms the front section of the passageway, and the rear part forms the middle and rear sections of the passageway. The front and rear parts of the hollow connector are connected to each other for use. However, when in use, the front and rear parts of the hollow connector may be separated from each other and may even be damaged due to back pressure generated by fluid in the passageway.

Tube couplings have been applied to filter devices. Referring to FIG. 1, a conventional filter device 91 includes a housing 911, a tube coupling 912 having one end which threadedly engages the housing 911, and the other end to which a tube (not shown) is connected. For the threaded engagement between the housing 911 and the tube coupling 912, threads have to be separately formed on the tube coupling 912 and the housing 911, thus the manufacturing process is relatively complicated.

Referring to FIG. 2, another conventional filter device 92 includes a housing 921, a connecting tube 922 disposed on the housing 921, and a tube coupling 923 having one end which is connected to the connecting tube 922, and the other end to which a tube 924 is connected. However, once the conventional filter device 92 is assembled, it is relatively difficult to detach the tube coupling 923 from the connecting tube 922 due to compact arrangement of the components of the conventional filter device 92. Furthermore, since the connecting tube 922 is needed for interconnecting the housing 921 and the tube coupling 923, manufacture and assembly of the connecting tube 922 add to the overall manufacturing cost of the conventional filter device 92.

Referring to FIG. 3, still another conventional filter device 93 includes a housing 931 and a tube coupling 932. The tube coupling 932 includes a connector body 933 which is connected to the housing 931, and a collet 934 which is movably connected to the connector body 933 and to which a tube (not shown) is connected. The connector body 933 of the tube coupling 932 and the housing 931 cooperatively define a passageway 935. The connector body 933 and the housing 931 respectively resemble the front and rear parts of the hollow connector by John Quest Ltd. When in use, the conventional filter device 93 may encounter the same back pressure problem as described earlier. That is, the connector body 933 of the tube coupling 932 may be detached from the housing 931 and may even be damaged due to the back pressure generated by the presence of fluid flow in the housing 931.

### SUMMARY

Therefore, the object of the disclosure is to provide a filter device that can alleviate at least one of the drawbacks of the prior arts.

According to the disclosure, the filter device includes a housing, a filter core, a cover, and a tube coupling. The housing defines an accommodating space and is formed with an opening that is in fluid communication with the accommodating space. The filter core is disposed in the accommodating space. The cover is connected to the housing and is disposed at the opening.

The tube coupling includes a connector body, a collet, a retaining member, and a seal ring. The connector body is connected to the cover, has an inner end part adjacent to the housing, an outer end part opposite to the inner end part, and a guiding part interconnecting the inner and outer end parts and defining a passageway. The passageway is in fluid communication with the accommodating space and extends through the inner end part, the guiding part, and the outer end part. The passageway has a tapering portion that tapers toward the outer end part. The tube coupling and the cover are molded as one piece. The collet is movably connected to the connector body, and has a ring-shaped base disposed outside of the outer end part, and a plurality of resilient arms extending from the ring-shaped base into the passageway. The retaining member is disposed at the inner end part. The seal ring is disposed in the passageway between the collet and the retaining member, and is retained in the passageway by the retaining member.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary partly sectional view of a conventional filter device;

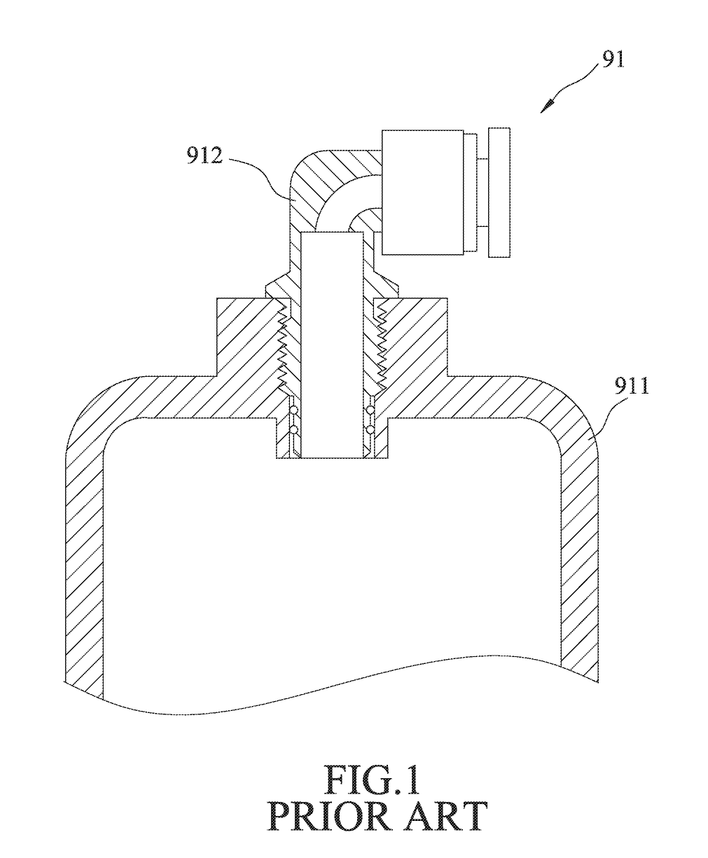

FIG. 2 is a partly exploded perspective view of another conventional filter device;

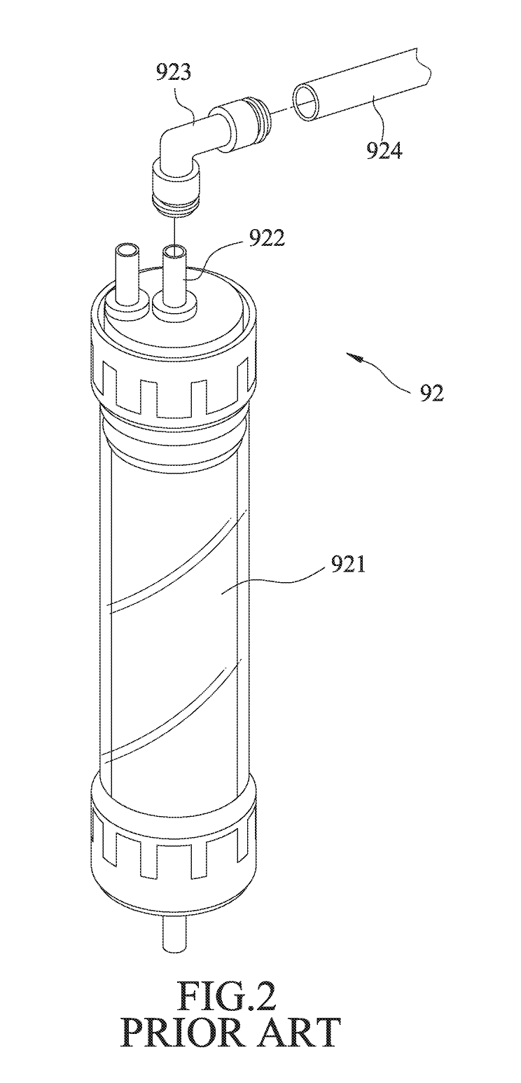

FIG. 3 is a fragmentary sectional view of still another conventional filter device;

FIG. 4 is a partly sectional view of an embodiment of a filter device according to the disclosure;

FIG. 5 is a fragmentary exploded sectional view of the embodiment and a tube;

FIG. 6 is a fragmentary partly sectional view illustrating that the tube is gripped by a tube coupling of the embodiment; and

FIG. 7 is a view similar to FIG. 6, but illustrating that the tube is released from the tube coupling of the embodiment.

### DETAILED DESCRIPTION

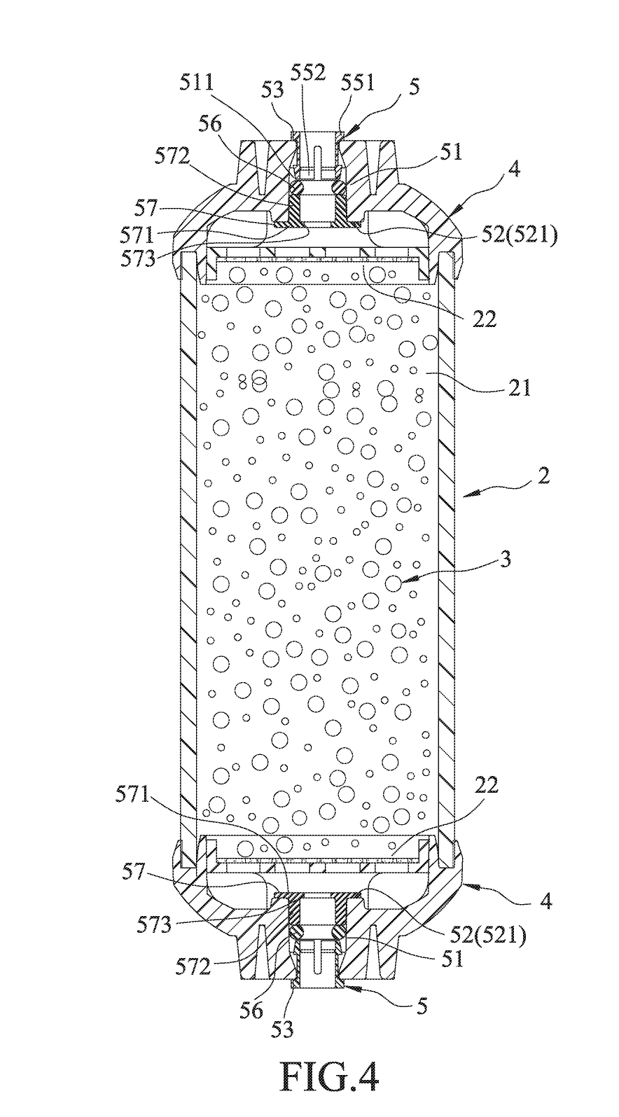

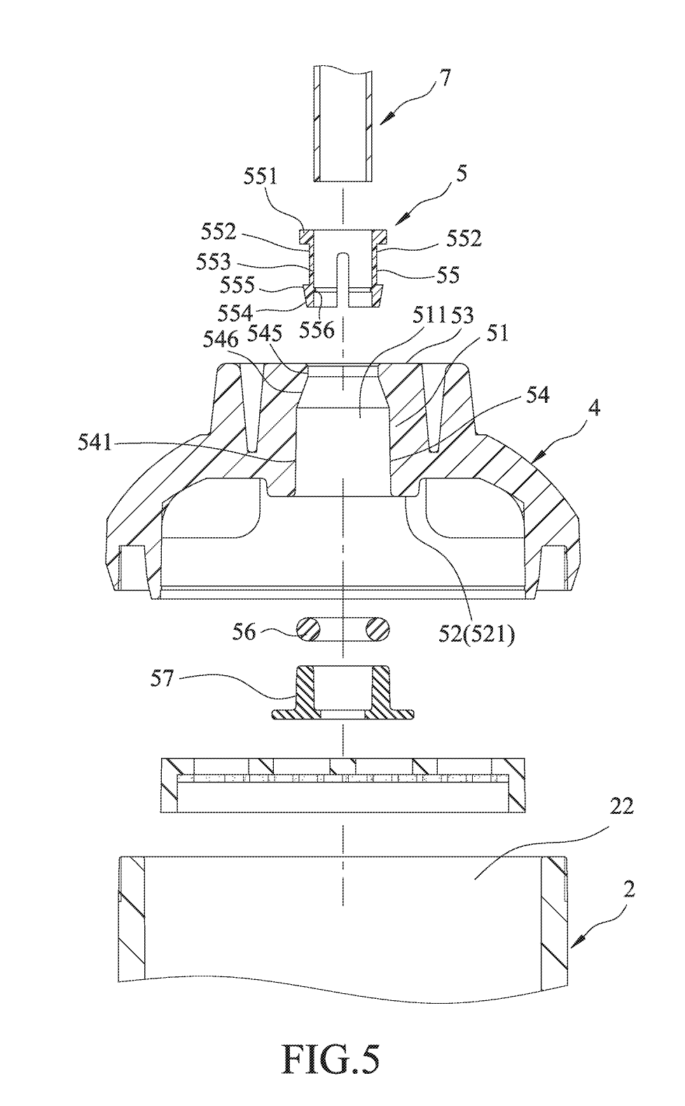

Referring to FIGS. 4 and 5, an embodiment of a filter device according to the disclosure is adapted to be connected to a tube 7 (see FIG. 5). The filter device includes a housing 2 defining an accommodating space 21 and formed with two openings 22 that are opposite to each other and that are in fluid communication with the accommodating space 21, a filter core 3 disposed in the accommodating space 21, two covers 4 respectively disposed at two opposite ends of the housing 2, and two tube couplings 5 respectively disposed at the opposite ends of the housing 2 and each being connected to a respective one of the covers 4. Since the covers 4 are identical in structure, and since the tube couplings 5 are also identical in structure, only one of the cover 4 and the respective one of the tube couplings 5 will be described in detail hereinafter for the sake of brevity.

The cover 4 is connected to the housing 2 and is disposed at one of the openings 22. The technique for connecting the cover 4 and the housing 2 may vary based on actual design needs. For example, the cover 4 may threadedly engage the housing 2, or may be connected to the housing 2 by ultrasound-assisted spin welding or by male and female engagement parts.

The tube coupling 5 includes a connector body 51, a collet 55, a retaining member 57, and a seal ring 56.

The connector body 51 is connected to the cover 4, has an inner end part 52 adjacent to the housing 2, an outer end part 53 opposite to the inner end part 52, and a guiding part 54 interconnecting the inner and outer end parts 52, 53. The inner end part 52 has an inner end surface 521 that faces the housing 2. The guiding part 54 defines a passageway 511 that is in fluid communication with the accommodating space 21 and that extends through the inner end part 52, the guiding part 54 and the outer end part 53. The passageway 511 has a tapering portion that tapers toward the outer end part 53. The tube coupling 5 and the cover 4 are molded as one piece.

More specifically, the guiding part 54 of the connector body 51 has an inner segment 541, an outer segment 545, and a converging segment 546. The inner segment 541 is connected to the inner end part 52 of the connector body 51. The outer segment 545 is connected to the outer end part 53, and has an inner diameter that is smaller than that of the inner segment 541. The converging segment 546 interconnects the inner segment 541 and the outer segment 545, and defines the tapering portion of the passageway 511.

The collet 55 is movably connected to the connector body 51, and has a ring-shaped base 551 disposed outside of the outer end part 53, and a plurality of resilient arms 552 extending from the ring-shaped base 551 into the passageway 511. The ring-shaped base 551 has an outer diameter larger than the inner diameter of the outer segment 545 of the guiding part 54 of the connector body 51. Each of the resilient arms 552 has an arm segment 553 extending from the ring-shaped base 551 into the passageway 511, and a head segment 554 formed at a distal end of the arm segment 553, and being movable between the inner segment 541 and the converging segment 546 of the guiding part 54 of the connector body 51 during a movement of the collet 55 relative to the connector body 51. The head segment 554 of each of the resilient arms 552 has an abutment portion 555 that protrudes toward the guiding part 54, and a grip portion 556 that protrudes inwardly and that is for tightly gripping the tube 7 which is inserted into the tube coupling 5 when the head segment 554 is at the converging segment 546 of the guiding part 54.

The retaining member 57 is disposed at the inner end part 52 of the connector body 51. The retaining member 57 includes a hollow body 572, an outer flange 571, and an inner flange 573. The hollow body 572 extends into the passageway 511 toward the outer end part 53 of the connector body 51. The outer flange 571 extends radially outward from the hollow body 572 and is fixedly connected to the inner end surface 521 of the inner end part 52 of the connector body 51. The inner flange 573 extends radially inward from the hollow body 572 and is for limiting an insertion of the tube 7 into the connector body 51. The outer flange 571 of the retaining member 57 is connected fixedly to the inner end surface 521 of the inner end part 52 of the connector body 51 by ultrasound-assisted spin welding, or by using an adhesive material, etc.

The seal ring 56 is received in the inner segment 541 of the guiding part 54 of the connector body 51, is disposed in the passageway 511 between the collet 55 and the retaining member 57, and is retained in the passageway 511 by the retaining member 57.

During assembly, first the seal ring 56 is disposed within the inner segment 541 of the connector body 51 of the tube coupling 5, and then the retaining member 57 is fixedly disposed on the inner end part 52 of the connector body 51. Next, the collet 55 is inserted into the passageway 511 so that the collet 55 is movably disposed at the cover 4.

To install the tube 7 on the filter device, first the collet 55 is pushed to move the ring-shaped base 551 of the collet 55 toward the outer end part 53 of the connector body 51, so that the abutment portion 555 of the head segment 554 of each of the resilient arms 552 is distal from the converging segment 546 of the guiding part 54 of the connector body 51. At this time, the abutment portion 555 of the head segment 554 of each of the resilient arms 552 is located within the inner segment 541, which permits the tube 7 to be smoothly and easily inserted into the collet 55. The installation is completed after the tube 7 extends through the seal ring 56 and abuts against the inner flange 573 of the retaining member 57.

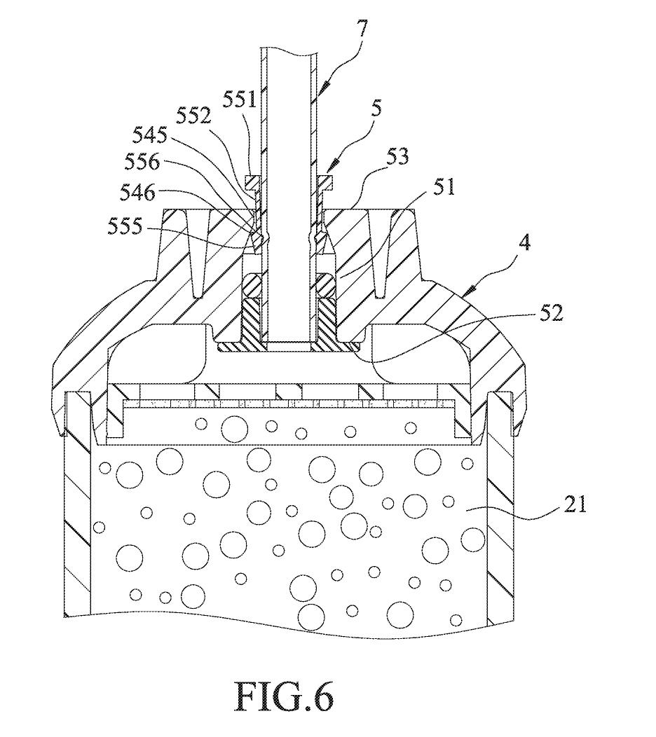

Referring to FIG. 6, since fluid pressure exists when the accommodating space 21 is filled with water, back pressure is generated whenever water is passed through the tube 7. The back pressure acts in a direction away from the accommodating space 21, which drives the ring-shaped base 551 of the collet 55 to move away from the outer end part 53 of the connector body 51. As such, the head segment 554 of each of the resilient arms 552 moves toward the converging segment 546 of the connector body 51, and the abutment portion 555 of the head segment 554 of each of the resilient arms 552 is pressed against by the converging segment 546 since the converging segment 546 converges toward the outer segment 545. As a result, the head segment 554 of each of the resilient arms 552 moves radially inward. In the mean time, the grip portions 556 of the head segments 554 tightly grip the tube 7 so as to prevent the tube 7 from being disconnected from the filter device.

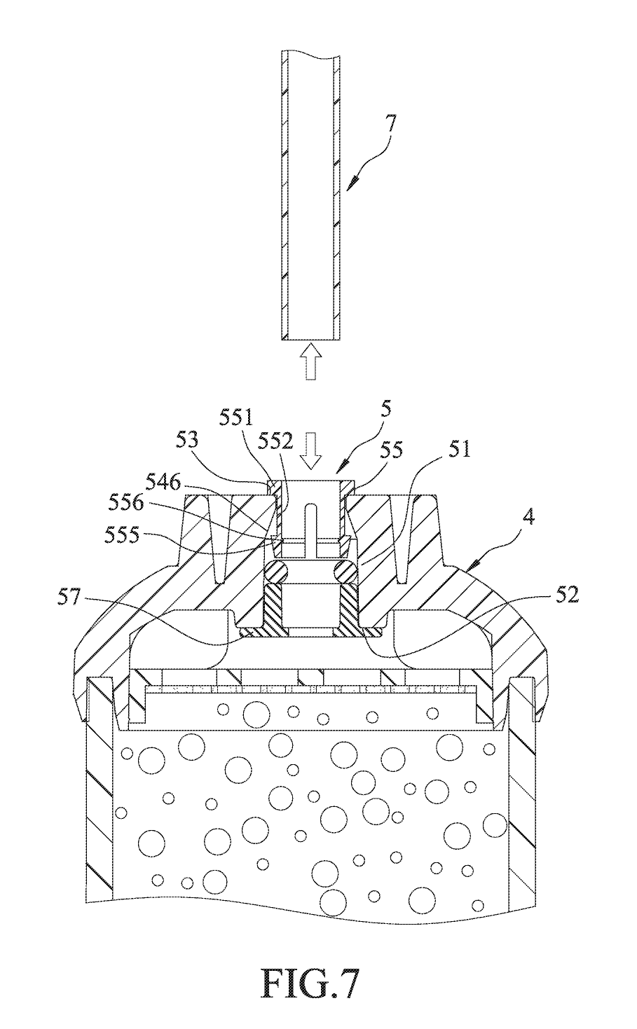

Referring to FIG. 7, to remove the tube 7 from the filter device, the ring-shaped base 551 of the collet 55 is pushed back to abut against the outer end part 53 of the connector body 51, so that the abutment portion 555 of each of the resilient arms 552 moves away from the converging segment 546 to release the tube 7. In this way, the tube 7 can be easily removed from the passageway 511.

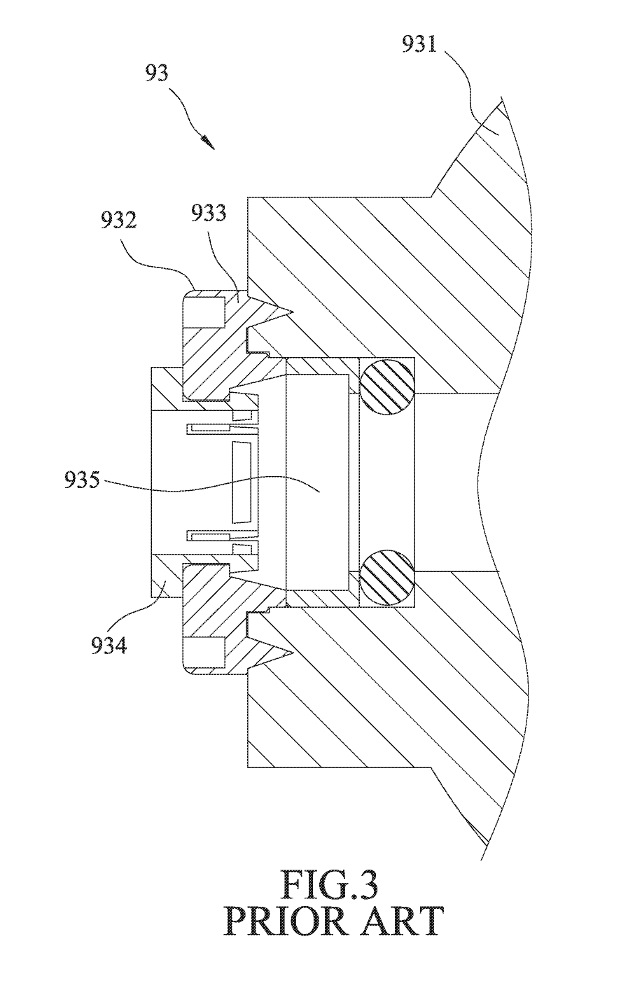

In summary, the retaining member 57 is disposed on the inner end part 52 of the connector body 51 of the tube coupling 5, and the connector body 51 and the cover 4 are molded as one piece. Therefore, the connector body 51 is prevented from separating from the housing 2 when the back pressure is generated. Thus, the filter device of the disclosure has an enhanced structural strength against the back pressure compared with the above-mentioned conventional filter device 93 (see FIG. 3).

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A filter device comprising:
a housing defining an accommodating space and being formed with an opening that is in fluid communication with said accommodating space;
a filter core disposed in said accommodating space;
a cover connected to said housing and disposed at said opening; and
a tube coupling including
a connector body that is connected to said cover, that has an inner end part adjacent to said housing, an outer end part opposite to said inner end part, and a guiding part interconnecting said inner and outer end parts, and defining a passageway that is in fluid communication with said accommodating space and that extends through said inner end part, said guiding part and said outer end part, said passageway having a tapering portion that tapers toward said outer end part, said tube coupling and said cover being molded as one piece,
a collet that is movably connected to said connector body, and that has a ring-shaped base disposed outside of said outer end part, and a plurality of resilient arms extending from said ring-shaped base into said passageway,
a retaining member that is disposed at said inner end part, and
a seal ring that is disposed in said passageway between said collet and said retaining member, and that is retained in said passageway by said retaining member.

2. The filter device as claimed in claim 1, wherein said guiding part of said connector body has:
an inner segment connected to said inner end part of said connector body and receiving said seal ring;
an outer segment connected to said outer end part and having an inner diameter that is smaller than that of said inner segment; and
a converging segment interconnecting said inner segment and said outer segment, and defining said tapering portion of said passageway.

3. The filter device as claimed in claim 2, wherein:
said ring-shaped base has an outer diameter larger than the inner diameter of said outer segment of said guiding part of said connector body; and
each of said resilient arms has
an arm segment extending from said ring-shaped base into said passageway, and
a head segment formed at a distal end of said arm segment, and being movable between said inner segment and said converging segment of said guiding part of said connector body during a movement of said collet relative to said connector body, said head segment having an abutment portion that protrudes toward said guiding part, and a grip portion that protrudes inwardly and that is adapted for tightly gripping a tube which is inserted into said tube coupling when said head segment is at said converging segment of said guiding part.

4. The filter device as claimed in claim 1, wherein:
said inner end part of said connector body has an inner end surface that faces said housing; and
said retaining member is connected fixedly to said inner end surface of said inner end part.

5. The filter device as claimed in claim 4, wherein said retaining member includes a hollow body extending into said passageway toward said outer end part of said connector body, and an outer flange extending radially outward from said hollow body and being fixedly connected to said inner end surface of said inner end part of said connector body.

6. The filter device as claimed in claim 5, wherein said retaining member further includes an inner flange extending radially inward from said hollow body and adapted for limiting an insertion of a tube into said connector body.
